(19) United States
(12) Patent Application Publication
(10) Pub. No.: US 2026/0263858 A1
(43) Pub. Date: Sep. 10, 2026

(54) UNIVERSAL CONNECTOR AND TUBE FORMING

(71) Applicant: SYSTEMS IP PTY LTD, Queensland (AU)

(72) Inventors: Joe Andon, Queensland (AU); Akira Yamada, Queensland (AU); Michael Williams, Queensland (AU)

(21) Appl. No.: 19/471,358

(22) PCT Filed: Apr. 1, 2024
(86) PCT No.: PCT/AU2024/050307

§ 371 Date: Sep. 30, 2025

(30) Foreign Application Priority Data
Apr. 1, 2023 (AU) 2023900926

(51) Int. Cl. A63B 5/11; B21D 15/02; B21D 41/04

(52) U.S. Cl. CPC A63B 5/11; B21D 15/02; B21D 41/04

(57) ABSTRACT

A method for forming a tube or pipe comprising an insertion portion is provided. The method comprises the steps of: obtaining a tube or pipe having an open end and a longitudinal axis; reducing the diameter of the open end of the tube or pipe by swaging the open end of the tube or pipe over more than one reduction step to reduce the tube or pipe diameter thereby producing a tube or pipe having a swaged open end; and internally forming a plurality of longitudinal splines, on the swaged open end of the tube or pipe, each spline having longitudinal edges that are optionally aligned with the longitudinal axis of the tube or pipe, thereby producing an insertion position on the tube or pipe for use in a coupler.

The present document claims priority to AU2023900926 entitled: Universal connector and tube forming, filed on 1 Apr. 2204 the contents of which are hereby incorporated by reference in their entirety.

### TECHNICAL FIELD

The present invention relates to a connector for connecting frame elements such as tubes or pipes. In an embodiment, the connector is used to connect frame elements of an apparatus that is intended to be walked on, swung on or jumped on in use. The apparatus could be a playground apparatus such as a climbing frame or a trampoline.

### BACKGROUND

When building a large structure, it is sometimes necessary to connect multiple pieces together. In the building industry, for example, a large structure of scaffolding can be required to accommodate access to a structure being built. The scaffolding comprises multiple rods or tubes connected to one another to provide a frame around the building. Construction workers will stand, move and work on the scaffolding during the day. Therefore, it is important that the scaffolding frame once in place is strong, robust and that the points of connection are unlikely to fail in use.

Other large structures that take the weight of persons in use include climbing frames, bunk beds and trampolines. A climbing frame can be formed from multiple rods or tubes connected to one another to provide a frame around which a child can swing and play. The child may climb, swing and jump around the frame and sometimes multiple children put all their weight on the structure at once. It is important that the frame is structurally robust and does not break, sway or loosen especially at connection points.

To provide optimum structural integrity to a frame, the number of joints in the frame can be minimised. The joint parts of the frame structure can be welded or otherwise permanently joined to form a connection that is immovable and unlikely to fail in use. However, there are circumstances where permanent joints are not appropriate. For example, in scaffolding, a permanent joint is not appropriate because the scaffolding should be removed once it is has served its purpose. In domestic playground apparatus, permanent joints may not be appropriate because the user may wish to disassemble the apparatus and move it when they e.g., re-design their backyard area, dispose of the apparatus, or move house. If the domestic playground apparatus is permanently assembled, the user's ability to relocate/resell the product is reduced, because the owner is not able to disassemble it and transport it to another location.

With it in mind that some structures need to be readily transportable and easy to assemble and disassemble, a means of connecting frame parts together becomes essential. Long pieces permanently joined together is no longer an option. Instead, pieces of the frame that are required to be long in length can come in smaller parts, each of which smaller part can be connected to the other to form an overall longer piece. For example, in a trampoline, the elongate tubular frame parts of the steel frame are often modular. Smaller frame elements can be connected together to make the overall frame structure. In children's climbing equipment such as monkey bars, the frame can be made from smaller frame pieces connected together to make the overall frame structure. In scaffolding, the tube parts used to form the scaffold frame can be connected together to form an infinitely extendable scaffolding that can grow with the building as more scaffolding is required. The tubular frame parts can be connectable along the same longitudinal length to make long frame elements as described. Furthermore, the tubular frame parts are desirously connected at the corners and or at other locations within the structure, so that the frame can take shape.

Turning back to trampolines, providing stability in a trampoline frame is a challenge since it is intended to be jumped on. For many years recreational trampolines have typically included a tubular steel frame which is supported on spaced apart legs with a flexible jumping mat secured to the frame by a large number of spaced apart extension springs which extend and contract as a person jumps on the mat in order to give “bounce”. The springs are usually connected to the tubular steel frame at one end via radial slots provided therein and to the mat via hooks or the like at the other end. Although trampolines can be made in many shapes, circular is probably the most popular in which case the frame is generally constructed of arcuate segments of round tube which are joined together in a spigot and socket arrangement with the end portion of one segment sliding into the end portion of the adjacent segment. Whilst a spigot and socket arrangement is generally useful, over time and following use, the spigot can tend to become wedged into the socket and the only means to remove it can be force. Sometimes tools are required to separate the spigot from the socket, which is not desirable. Furthermore, where the mat support frame joins to the vertical support frame elements such as the legs of the trampoline, the connection should be robust and strong. A connector that can securely join frame pieces and which does not require force to disassemble is preferred for the domestic market.

Accordingly, there exists a need for joining frame elements that allows for the building of robust structures that do not sway or loosen at connection points even under the application of intended user load. Furthermore, the means of joining the frame elements should allow for relatively easy disassembly even after a period of prolonged use. It would also be advantageous if the connector was a universal connector that allowed for the joining of multiple types of frame elements so that the user has improved choice when designing bespoke structures. It would also be advantageous if the connector was fun to use during construction.

The present invention is aimed at providing an improved connector which can ameliorate at least some of the problems of the prior art or which can provide a useful alternative.

### SUMMARY OF INVENTION

In a first aspect there is provided a method for forming a tube or pipe comprising an insertion portion, the method comprising the steps of:
obtaining a tube or pipe having an open end and a longitudinal axis;
reducing the diameter of the open end of the tube or pipe by swaging the open end of the tube or pipe over more than one reduction step to reduce the tube or pipe diameter, thereby producing a tube or pipe having a swaged open end;
internally forming a plurality of longitudinal splines, on the swaged open end of the tube or pipe, each spline having longitudinal edges that are optionally aligned with the longitudinal axis of the tube or pipe, thereby producing an insertion position on the tube or pipe for use in a coupler.

The appendix attached hereto is based on the written description of invention described in International (PCT) Patent Application PCT/AU2022/051598 in the name of Systems IP Pty Ltd, entitled: UNIVERSAL CONNECTOR. The entire contents of PCT/AU2022/051598 are hereby incorporated by reference.

In the Appendix attached hereto, there is described a universal connector that can be used to connect tubes or pipes. While tubes and pipes differ in how they are made, it should be understood that references to tubes herein includes pipes and visa versa. The tube or pipe terminology refers to any frame element with a hollow interior. The universal connector described in the appendix has a frame element with an insertion portion (male part) and a first connector that can receive the insertion portion (female part). The first connector can also be associated with one or more frame elements, so that tubes can be joined to one another. A second connector mates with the first connector to form the universal connector.

Each frame element can have an elongate body. The body can be straight or curved. The body of the frame element can have any cross-section. The most typical cross-section for frame elements is circular, although the invention is not limited to frame elements of this shape. In an embodiment, the cross section is at least about 40, 45, 48 mm in diameter although any sized tube or pipe could be subject to the present process. The frame elements can be made from any material. In an embodiment, the frame elements are made from metal. The frame element can be made from a plastic material. The elongate body can have a first end and a second end. The first end and the second end can be identical except in the case of frame elements where the thickness or shape of the frame element changes along its length. The first end of the frame element can be for joining with the second end of another, separate frame element. The second end of the frame element can be for joining with the first end of another, separate frame element.

The first ends and the second ends can in principle be joined together in perpetuity. However, at some point, there may be a natural end of the structure, which will result in an end of a frame element that is not joined to another frame element. The ends of the frame elements which are not joined to other frame elements can be capped. There may be no free ends if the structure is such that all ends of the frame elements are connected, such as in a cuboidal shape.

In the universal connector described in the Appendix, the insertion portion of the frame element is described as follows: The end of the frame element that will join with the connector can have an insertion portion. The insertion portion is intended for insertion into the body of the first connector. The insertion portion can be of any length. If the insertion portion is too short, there is a risk that the point of connection is not strong enough and the frame element may move too much in the first connector. It is preferred that the insertion portion is at least equal in distance along the frame element to the diameter of the frame element. For example, if the diameter of the frame element is N cm, then the insertion portion is at least equal to N cm. In some embodiments, the insertion portion is at least about twice, 5, 10 or 15% greater in length than the diameter of the frame element. If the frame element is not round (and therefore has no diameter) then instead of the diameter, the distance can be measure as the longest length from one side of the cross section to the other e.g. in a square, the diagonal distance from opposing corners.

In an embodiment, the insertion point can comprise one or more protrusions around the frame element body. The function of the protrusion(s) is to provide a part of the frame element that can be gripped between the first connector and second connector members in use. In an embodiment, the protrusion(s) on the frame element can be identified as the part which stops the insertion portion from being further inserted into the channel. Alternatively (or in addition), the protrusion(s) can be identified as the part that abuts the barrier wall of the second connector member and substantially prevents or at least reduces removal of the frame element from the first connector member. In an embodiment, the protrusion can be threaded for mating engagement with the second connector which can be correspondingly threaded.

The universal connector joins two frame elements at their open ends. Once the frame elements are joined as described, the connection is structurally stable. However, given that the tubes or pipes that comprise the frame elements do not need to carry liquid the join does not need to be water tight. There can be holes in the tubes or pipes. Furthermore, the seal between the insertion portion and the first connector does not need to be water-tight. Since the tube or pipes do not need to be sealed, the means of connecting the elements does not have to be to the level that a water tight connection might be required to meet. The tube or pipes are not water carrying, which allows there to be sealed parts in the pipes or sealed walls at the rear of the first connector. There is not one continuous passage through the joined frame elements through which a liquid can flow.

In an embodiment, the insertion portion is different in diameter to the remainder of the elongate body of the frame element. This can be useful where the insertion portion slides into the first connector member and is secured into position by a second connector member where the outside surfaces of the elongate body of the frame element and second connector member can be substantially flush with one another. There can be some step in the change between surfaces. However, being as flush as possible can provide a more aesthetically pleasing join that is also functionally useful if, e.g. something needs to slide along connected frame elements.

In a frame element with a substantially circular or ovaloid cross section, where there is a single peripheral protrusion, the protrusion can be referred to as a circumferential protrusion. In frame elements with other shapes, such as triangular, the formation of a protrusion around the outside surface can be referred to as circumferential, even though it will be appreciated that it is not circular in shape. Nevertheless, the protrusions can trace around the outside of the frame element body and provide an area of increased diameter or increased cross sectional width for the frame element. The increase in cross sectional area can be relative to the remainder of the body of the frame element that does not comprise the protrusion(s).

In the Appendix, it is noted that the protrusions can be provided on the frame element. In an embodiment as then described, the frame element is manufactured with the protrusion(s). Thus, the protrusions are integral with the frame element and cannot be removed from the frame element. It is also said in the Appendix that alternatively, the protrusions are provided on an element that is attachable to the frame element. However, here the present invention departs. In the description of the Appendix, the end of the frame element can be capped with a sleeve that has a part of it comprising one or more protrusions around its outside periphery. However, in the present invention, there is no cap or sleeve. This is because the present inventors prefer that the insertion portion and the frame element are integral with one another. The present invention is predicated on how to form the suitable insertion portion into the material of the frame element.

There are some advantages to having the insertion portion integral with the frame element. For example, when otherwise separate metal parts are integral with one another, they form a continuous structure that is stronger and more rigid than separate pieces that are joined together. This is because separate pieces may have weak points at the points where they are joined, such as welds or fasteners, which can compromise the strength of the overall structure. Furthermore, integral metal parts are typically more durable than separate pieces because they are less likely to experience wear and tear at the points where they are joined. This can be especially important in applications where the parts are subject to heavy use or exposure to outdoor environments. In many cases, forming metal parts as integral pieces can be more cost-effective than creating separate pieces and then joining them together.

Forming the insertion portion integrally with the frame element however is not an easy task. Working with a hollow metal structure presents unique challenges that need to be overcome in order to get a good result. Much of the prior art in the space of working with metal structures relates to metal rods. Metal rods are solid cylindrical shapes, while metal tubes or pipes are hollow cylindrical shapes. Because of their hollow shape, metal tubes and pipes have greater structural strength-to-weight ratios than solid rods of the same size and material. This makes them useful in applications where strength is important, but weight needs to be minimized. When working with the ends of metal rods, one can usually drill, cut, or weld them directly since the end is solid and does not have a hollow cavity. However, when working with metal tubes or pipes, it is important to consider the effects of the hollow cavity on the properties of the material. For example, when cutting a tube or pipe, the cutting tool can deform the end of the tube or pipe due to the pressure exerted by the tool on the walls of the cavity. This can lead to distortion or warping of the end of the tube or pipe.

The present frame element must be modified so as to have an insertion portion delimited by at least one protrusion, and so that it comprises a plurality of frame element rotation reducing portions in the form of longitudinal splines. In an embodiment, as described below, the protrusion may be formed by the end parts of the longitudinal splines themselves. The inclusion of these required features into the metal of the frame element increases the complexity of manufacture. Some more detail is now provided on each of the features.

There can be one circumferential protrusion. In the case of a frame element with a circular cross-section, the protrusion can be an annular ring. The annular ring can be integral with the frame element. Alternatively, the annular ring can be a gasket-like piece that is arranged around the outside surface of the insertion portion to provide an area of increased diameter. By gasket-like it is meant that the protrusion is provided as a separate piece, such as a plastic collar, that provides a mechanical seal that fills the space between the two mating surfaces of the insertion portion and the channel of the first connector. The gasket-like protrusion can be advantageous in increasing friction and may even allow for the rotation reducing portions to be removed. However, when used in combination with the rotation reducing portions, there can be a superior reduction in unwanted rotation.

The annular protrusion can be a solid shape with squared edges. The ring can have rounded edges. There can be a preference for solid edges as will become apparent from the description herein, since the protrusions will thus be sandwiched without air spaces between the first and second connector members if they have squared edges. Since the function of the protrusion is to provide an area of increased diameter on the frame element, the protrusion does not have to be a solid ring around the element body and instead it can be provided in parts. Where the protrusion is provided in parts it can be referred to as a series of protrusions around the outside periphery of the frame element. The series of protrusions can be of any shape such as knobs, squared, rectangular columns, other. Each protrusion can be formed into the material of the frame element e.g. by moulding, pressing or crimping. In the Appendix, it is stated that each protrusion can be material added to the frame element e.g. by adhering a solid piece or adding a rivet. However, it should be understood now that more aligned with the spirit and scope of the present invention is a protrusion or set of protrusions that are integrally formed in the metal of the frame element at the insertion portion. The protrusion(s) can be hollow. The protrusion(s) can be solid. There can be any number of protrusions around the outside periphery in a series including 2, 3, 4, 5, 6, 7, 8, 9 or 10. If there are too many protrusions, the risk is that they become a point of weakness since the surface area joining them to the underlying structure gets less and they could break off more easily.

In an embodiment there can be a single protrusion that does not cover the entire circumference (or periphery) of the frame element. Nevertheless, the protrusion can act to provide a part of the frame element that can be gripped by the first connector and second connector members in use. It should be understood that such a single protrusion is in scope but may not be preferred due to the decreased amount of surface area for gripping for the first and second connector members.

The amount that the protrusions extend from the frame element surface can vary. However, the protrusion or protrusions should not be so short that they are unable to provide a good functional surface for gripping by the connector members; or so that there is a risk that the insertion portion could be pushed too far into the first connector and get stuck. On the other hand, the protrusion or protrusions should not extend out so far that they are unsightly, difficult to manufacture, hamper handling and generally cause a nuisance. In a preferred embodiment, the protrusion(s) increase the diameter of the frame element by about 10 to about 20%, more preferably about 15 to about 18% from the original diameter of the frame element. For example, if the diameter of the frame element is 5 cm, the protrusion(s) can extend about 0.5 cm to thereby increase the overall diameter by 1 cm (about 20%). If the diameter of the frame element is 3.5 cm (measured from outside wall) then the diameter of the frame element can be increased to about 3.9 cm by the protrusions (about 10%).

The protrusion(s) whether in single form or parts can be formed by or accompanied by longitudinal splines (described in (b) below) which can be axially fixed and which allow for indexing of the frame element with the first connector. The axially fixed indexed splines extend along at least a part of the longitudinal length of the insertion portion. The protrusions can be the leading edges of the axially fixed indexed longitudinal splines. These splines can assist with decreasing rotation of the frame element once inserted into the first connector member if there are corresponding grooves between complementary ribs inside the channel of the first connector to reduce rotation.

In some embodiments, there are no splines on the insertion portion. Instead, rotation reduction is achieved through friction with the splineless insertion portion being wedged into the first connector so tightly that it cannot rotate. In an alternative embodiment there are a plurality of axially fixed longitudinal splines around the outside periphery of the insertion portion. Each spline can be in one single piece. Each spline can be formed in multiple pieces with lands between elongate spline parts. Each spline can be at least or at most 2, 3, 4, 5, 6, 7 or 8 mm (or larger) in thickness from one side of the spline to the other. The spline can be formed in two or more longitudinal spline parts to reduce the amount of material used to form it. The spline can be across 75, 80, 85, 90, 95 or 100% the distance of the insertion portion. Although there should be at least some part of the insertion portion free from the location of the barrier wall of the second connector member. In an embodiment in which there is a gasket-like collar to provide the protrusion, the splines can be shortened along their longitudinal length to ensure that there is enough room for the gasket-like collar to slide along the insertion portion, and so that the collar slides far enough into the channel of the first connector.

Each spline can have an elongate axis substantially aligned with the longitudinal axis of the frame element; this is the most straightforward arrangement since the frame element is most easy to insert into the first connector member. In an alternative embodiment, each spline is offset with respect to the longitudinal axis of the frame element. In this embodiment, the arrangement is slightly more complicated because the receiving channels for the offset splines still need to be able to receive and mate with them to prevent or reduce rotation. In an embodiment with angled offset splines, the channels for receiving them will need to be wider, which results in less overall contact between frame element and first connector. There is still likely to be an overall reduction in rotation, but the optimum reduction is where straight splines contact with straight ribs in the channel of the first connector. In an embodiment described in the Appendix, the splines are said to be optionally curved so that they mate with the corresponding parts of the first connector member upon rotational insertion into the first connector member; however, forming curved splines into a metal tube or pipe is likely to present a big challenge not least in how the metal of the tube will change as the splines are formed along its length.

Advantageously, the splines are straightforward to produce in metal and do not affect the overall structural integrity of the frame element in use. In order that the splines are repeatedly matingly received into a first connector member it is preferably that each spline is the same. The splines can be the same across multiple frame elements, so any frame element can be mated into any first connector. In an embodiment, the splines can be different around a single frame element so that there is only one way in which they can possibly be inserted into a correspondingly shaped first connector member. This would increase complexity during construction but may provide some advantages such as forcing a particular orientation of respective frame elements relative to one another.

There can be any number of splines around the outside periphery of the insertion portion. There could in principle be a single spline with a corresponding channel on the inside surface of the first connector member; however, to optimise a reduction in rotation of the frame element in the first connector member, preferably there are splines all the way around the outside of the insertion portion. The splines can be equidistant from one another. There can be at least or at most 3, 4, 5, 6, 7, 8, 9, 10 or more splines. Around the insertion portion, using the centre of a spline as a reference point, there can be one spline every 45 degrees resulting in a total of 8 equidistant splines.

It is noted that with frame elements in which there is a bend or an elbow, the insertion of the insertion portion of the frame element into the first connector member needs to be in a particular way in order that the frame element lines up with other connectors. This indexing of the splines as they are mated into the first connector means that sometimes the frame element has to be inserted in a particular way for a frame to be formed. If there are too many splines, a chance that the frame element with an elbow is not oriented in the correct way are increased and the user has to keep removing the insertion portion and trying again to achieve the correct assembly. With this in mind, it is considered that about eight splines is optimal for reducing rotational movement between the frame element and the first connector member and for ease of construction.

Each spline has a first longitudinal side and a second longitudinal side. When the insertion member of the frame element is inserted into the first connector member the spline can slide into a channel or groove formed in the inside wall surface of the first connector member. Each elongate spline receiving groove in the channel in the first connector member can be formed between longitudinal ribs. Each rib of the first connector member can have a first side and a second side. The first side of the rib can abut with the first longitudinal side of a spline once the spline has slid into the groove and the two are unable to pass over one another. This means that rotational forces applied to the frame element are absorbed by the splines and ribs and the frame element is prevented or substantially reduced from rotating inside the first connector member. Optionally, a gasket like material can be provided between each longitudinally connecting part to further reduce any chance of rotation when there is connection. The gasket-like material can be applied to any one of the splines or ribs. The application could be by spraying a material over the surfaces of the parts.

When forming the splines, it is important that the wall thickness of the tube or pipe remains reasonably consistent after the splines are formed in order to maintain the structural integrity of the tube or pipe. If the splines are too deep or too narrow, they could potentially weaken the wall of the tube or pipe, leading to structural failure or other issues. Similarly, if the splines are not evenly spaced or aligned, they could create stress concentrations or other areas of weakness in the tube or pipe. With this in mind, certain spline shapes may be more difficult to form than others. For example, curved splines as noted above may require more complex tooling and machinery to form, which could increase manufacturing costs and lead times.

Tapered splines present some unique challenges. When forming tapered splines on a metal tube or pipe, it is important to ensure that the taper is uniform and consistent along the entire length of the spline. Any variations in the taper could result in stress concentrations or other areas of weakness in the tube or pipe. Accordingly, preferably the splines are not curved. Furthermore, preferably the splines are not tapered. In an embodiment, the splines are straight with all edges aligned with the longitudinal axis of the frame element.

When forming splines on a metal tube or pipe, it can be important to consider the thickness of the tube or pipe wall, as the process of forming splines can result in material displacement and thinning of the tube or pipe wall in the spline areas. Therefore, it may be necessary to use a thicker tube or pipe wall in order to achieve the desired spline shape and thickness while maintaining the structural integrity of the tube or pipe. The specific thickness required would depend on factors such as the material being used, the shape and dimensions of the splines, and the intended application of the tube or pipe. Longitudinal straight splines have the same cross section along the end of the insertion portion, and so the wall thickness change along the length of the spline is the same. With tapered splines, it would be very difficult to maintain this uniform tube wall thickness. At the deepest point of the spline from the end of the tube, the material of the tapered spline would likely be thicker than at the open end of the tube where the spline is at the widest point. With changes in wall thickness comes increased propensity for material failure in the form of ripping and or shearing of the metal, and the tube may become weaker at the end of the tube. In some embodiments, however tapered splines can be an advantage particular in further reducing any rotation of the frame element once inserted into the first connector. Accordingly, the thickness of the tube needs to be taken into consideration when forming tapered splines.

In an embodiment, the wall thickness of the pipe or tube prior to forming the splines is not more than about 1.2 mm to about 2.5 mm, such as being in the range of from about 1.55 to about 2.5 mm. Preferably, the wall thickness is about 1.75 to about 2 mm. In one or all embodiments, the wall thickness is 1.75, 1.8, 1.9 or 2 mm.

The splines can be formed in the pipe or tube wall using a flaring technique expands the end of a tube or pipe to increase its diameter. However, it should be understood that flaring will cause a decrease in wall thickness and may result in a weakened insertion portion when compared to the remainder of the frame element. Alternatively, the pipe or tube is first swaged to reduce its diameter. This has the added benefit of building a shoulder into the frame element so that the insertion portion is reduced in diameter compared to the rest of the frame element.

Preferably, when reducing the diameter, the tube does not form a buckle or a lump at the location where the diameter changes due to an increase in material that is not able to smoothly change in shape. A buckle or lump would be apparent to the user since when drawing their hand along the length of the tube, there would be an increase in diameter just before the shoulder of the insertion point. The shoulder can have an angle in the range of from about 40 to about 50 degrees, preferably about 45% (where 0% is the longitudinal axis of the frame element). The shoulder can accommodate the second connector member and allow for a flush join between tubes in a tube to tube join. However, in some embodiments, the shoulder is in the range of from about 20 to about 40 degrees, preferably, about 20 to about 30 degrees such as 25 degrees so as to reduce the likelihood of a buckle being caused by the application of too much force during swaging.

The swaging can be undertaken in a single step. In an embodiment, the swaging is undertaken in multiple steps. The multiple steps reduce the diameter of the tube or pipe stepwise. The multiple steps can comprise 2, 3, 4, 5, or 6 steps. In an embodiment, each swaging step can reduce the diameter of the tube or pipe by about 4 to about 10%. The overall reducing in the tube or pipe diameter can be in the range of from about 15% to about 35% such as about 20 to about 30%.

The swaging is on the end portion of the tube or pipe. Preferably at least the end about 10, 9, 8, 7, 6, 5 or 4 cm of the tube or pipe is swaged. In an embodiment the resultant formed end including splines and shoulder is about 7 or about 8 cm in length. In an embodiment the resultant formed end is 76 mm. The amount inserted into the first connector will be about 5 or 6 cm such as about 59.5 mm.

By way of example only, a tube with a 1.6 mm wall diameter can be reduced in diameter from about 44.5 mm to about 34.5 mm over 4 steps. In the first step, the diameter is reduced to 42 mm. In a second step the diameter is reduced to about 38.5 mm. In a third step the diameter is reduced to 36 mm and in a fourth and final step the diameter is reduced to about 34.5 mm.

Reduction=(Initial Diameter−Final Diameter)/Initial Diameter×100%

The reduction at each stage is:

$$Swaging step 1 : \% Reduction = ( 4 4.5 - 42 ) / 44.5 \times 100 \% = 5.62 \%$$

$$Swaging step 2 : \% Reduction = ( 42 - 38.5 ) / 42 \times 100 \% = 9.52 \%$$

$$Swaging step 3 : \% Reduction = ( 3 8.5 - 36 ) / 38.5 \times 100 \% = 6.49 \%$$

$$Swaging step 4 : \% Reduction = ( 36 - 34.5 ) / 36 \times 100 \% = 4.17 \%$$

$$\% Reduction = ( 44.5 - 34.5 ) / 44.5 \times 100 \% = 22.47 \%$$

In an embodiment a tube with a 1.6 mm wall diameter can be reduced in diameter from about 44.5 mm to about 34 mm over 4 steps. In the first step, the diameter is reduced to about 41 mm. In a second step the diameter is reduced to 38.5 mm. In a third step the diameter is reduced to about 36 mm and in a fourth and final step the diameter is reduced to 34 mm.

$$Reduction = ( Initial Diameter - Final Diameter ) / Initial Diameter \times 100 \%$$

The reduction at each stage is:

$$Swaging step 1 : \% Reduction = ( 44.5 - 41 ) / 44.5 \times 100 \% = 7.87 \%$$

$$Swaging step 2 : \% Reduction = ( 42 - 38.5 ) / 42 \times 100 \% = 6.10 \%$$

$$Swaging step 3 : \% Reduction = ( 3 8.5 - 36 ) / 38.5 \times 100 \% = 6.49 \%$$

$$Swaging step 4 : \% Reduction = ( 36 - 34 ) / 36 \times 100 \% = 5.56 \%$$

$$\% Reduction = ( 4 4.5 - 34 ) / 44.5 \times 100 \% = 17.07 \%$$

To demonstrate that fewer than 4 steps can be used a 2 step process is now exemplified. In this embodiment a tube with a 1.6 mm wall diameter can be reduced in diameter from about 50 mm to about 39.5 mm over 2 steps. In the first step, the diameter is reduced to about 44.75 mm. In a second step the diameter is reduced to 39.5 mm.

$$Swaging step 1 : \% Reduction = ( 5 0. - 44. 75 ) / 50. \times 100 \% = 10 \text{.5} \%$$

$$Swaging step 2 : \% Reduction = ( 44 \text{.75} - 39.5 ) / 44.75 \times 100 \% = 11.76 \%$$

$$\% Reduction = ( 5 0. - 39.5 ) / 50. \times 100 \% = 20.0 \%$$

The swaging can be undertaken using known swaging equipment at standard temperatures and pressures. After swaging, the thickness of the wall of the tube will have increased slightly.

The swaged tube or pipe can then be subject to internal forming or internal splining. A mandrel can be used to form the splines in a tube or pipe. A mandrel tool or rod is inserted into the tube or pipe to support the inner diameter and shape of the tube or pipe. The diameter of the mandrel is selected to closely match the diameter of the swaged tube or pipe. For example, the mandrel can have an outer diameter of about 34. mm. A lubricant can be applied to assist insertion of the mandrel into the opening in the end of the swaged tube or pipe.

The mandrel is shaped to have the desired spline shape and size. The resultant spline height can be at least about 1 or about 2 mm each with smooth curved walls along the longitudinal sides. The angle of the splines curved longitudinal walls can be about 25 to 35 degrees such as 29 degrees. The height difference from the valley between the splines to the top of a spline can be about 1.5 to 1.7 mm such as 1.65 mm.

The tube or pipe can be then placed over the mandrel and pressed or rolled into the spline shape using pressure from rollers or other forming tools. The amount of pressure applied during the forming process can be adjusted to control the depth and shape of the spline. Multiple passes with the forming tool may be necessary to achieve the desired spline shape. In an embodiment, forming tools are used that have a complementary spline shape to the mandrel.

When the mandrel is removed from the pressed tube or pipe, the splines may be caught or stuck, which could damage or deform the splines. To reduce unwanted damage, the splines can be formed with ramps that provide a gradual transition from the thicker spline section to the thinner section of the tube, allowing the splines to easily slide off the mandrel mould without getting caught. The ramps may also be designed to prevent or at least reduce the formation of sharp edges or corners on the splines, which can weaken the spline and increase the likelihood of stress concentrations and fractures. By providing a smooth transition from the spline to the tube, the ramps can help to distribute stress more evenly, reducing the likelihood of failure. In an embodiment, the ramps are angle in the range of from about 45 to 55 degrees, preferably 50 degrees (where 0 degrees is the longitudinal axis of the frame element).

Once the pressing process is complete, the end of the tube around the periphery of the opening may require trimming of excess material to ensure a flat smooth surface. Trimming removes any excess material from the edge of the newly formed insertion portion. Trimming can be done using a variety of cutting tools, such as shears, saws, CNC machines or rotating face mill. The choice of tool depends on the material being trimmed, the complexity of the shape, and the desired level of precision. In an embodiment, the trimming is undertaken using a saw or a cutting wheel. The rough end of the tube or pipe is clamped in place, and a saw or cutting wheel is used to remove excess material, leaving a smooth, even surface. The trimmed edge can then then deburred to remove any sharp or rough edges that might interfere with the assembly process.

In an embodiment, the insertion portion formed with splines has a length in the range of from about 50 mm to about 80 mm such as about 55 to about 65 mm. The end diameter of the newly pressed insertion portion, not including the splines is about half the length of the splines themselves. After internal forming, the thickness of the wall of the tube may be the same, or it may have reduced slightly.

Preferably, the thickness does not reduce to less then 1.6 mm. In an embodiment, despite the swaging and the internal forming, the thickness of the tube wall is approximately equal to the thickness of the tube before the swaging and internal forming process. This is achievable due to careful selection of amount of swaging and then the selection of the ideal number of splines with the ideal amount of protrusion from the swaged surface.

The resultant frame element with integral insertion portion can be formed to complement the shape and dimensions of a first connector member.

In order to complete the connector, the second connector member is brought into contact with the first connector member. The act of bringing the two members (first connector member and second connector member) into contact can comprise bringing either one of them towards the other. However, in practice, since the frame element is typically already inserted into the first connector member, the act of bringing the second connector member into contact with the first connector member comprises bringing the second connector member to the first connector member.

Once in place, in an embodiment, the second connector member can provide a barrier wall that abuts the second side of the protrusion or series of protrusions. The barrier wall thereby prevents any removing movement of the frame element from the channel of the first connector member. The barrier wall can be provided as one continuous wall covering the second side of the protrusion or series of protrusions. In an embodiment in which the protrusion is threaded, the barrier wall can also be threaded. This can allow the two to matingly connect.

The barrier wall can be provided in separate wall parts provided that the protrusion or series of protrusions are associated with it either by abutting with it or threadedly mating with it and their movement is barred.

In an embodiment, the second connector member is in one part. This can be particularly advantageous when joining tube to tube. When the second connector member is in one part, it is necessary that it has a passageway therethrough to receive the frame element. The second connector member can be passed over the frame element and brought towards the insertion portion inside the channel of the first connector member. Once in place around the first connector member, the second connector member may provide a barrier wall associated with the protrusion or series of protrusions. The protrusion(s) may be as described herein integral with the insertion portion. The second connector can advance towards the first connector along the frame element and towards the insertion portion of the frame element along which it is advancing. In embodiment in which the protrusion and second connector thread together, the second connector will advance towards the first connector along the frame element comprising the first connector.

In an embodiment, the second connector member is in two parts as described further in the Appendix.

The second connector member comprises a connection assembly. The connection assembly can be associated with the barrier wall. The connection assembly is configured to engage the second connector member with the first connector member to prevent removal of the second connector member from the first connector member. The function of the connection assembly is to prevent unintentional disengagement of the second connection member from the first connection member. This can prevent unintentional disengagement of the barrier wall from the second side of the protrusion or series of protrusions, which would be disadvantageous in embodiments in which the barrier wall is holding the whole system together. The connection assembly can be any means that reversibly connects the second connection member to the first connection member.

In an embodiment, the connection assembly is a series of complementary rib(s) and recess(es) (or protrusion(s) and aperture(s); or like) on the outside wall of the first connector member and the inside wall of the second connector member that are complementary shapes and which upon engagement cause the first connector member and the second connector member to be interlocked together to prevent disengagement of the second connector member. The connection assembly can also prevent any rotational movement of the second connector member relative to the first connection member when locked into position. In an embodiment of the connection assembly, the complementary ribs and recesses on the outside wall of the first connector member and the inside wall of the second connector member come in the form of screw threads. In this embodiment, the second connector member can be screwed onto the first connector member to be interlocked. In an embodiment in which the second connector member is forms in parts, the parts can be assembled and then the assembled second connector member can be screwed onto the first connector member.

In an alternative embodiment of the connection assembly, the complementary rib(s) and recess(es) on the outside wall of the first connector member and the inside wall of the second connector member come in the form of a ridge on the first connector member which is wider in diameter than the whole in the second connector. In this embodiment, the second connector member can be screwed onto the protrusion of the frame element to be interlocked. In an embodiment in which the second connector member is forms in parts, the parts can be assembled and then the assembled second connector member can be screwed onto the first connector member. In this embodiment, the other end of the second connector remote from the threaded connection is a ridge or protrusion that abuts with the second connector wall.

### BRIEF DESCRIPTION OF THE FIGURES

Embodiments of the invention and other embodiments will now be described with reference to the accompanying drawings which are not drawn to scale and which are exemplary only and in which:

FIGS. 1 to 56 are incorporated by reference from PCT/AU2022/051598 in the name of Systems IP Pty Ltd, entitled: UNIVERSAL CONNECTOR. The entire contents of PCT/AU2022/051598 are hereby incorporated by reference.

FIG. 1 is an embodiment of a tube or pipe frame element prior to the process.

FIG. 2 is the frame element of FIG. 1 following the process to form the insertion portion.

FIG. 3 shows three exemplary mandrels for forming the longitudinal splines.

FIG. 4 shows the mandrel in position ready to perform the internal forming process.

FIG. 5 is the complementary forming tool that works together with the mandrel of FIG. 4 to form the splines.

FIG. 6 is a view down the open end of the insertion portion once formed.

FIG. 7 is the technical drawing used to achieve the insertion portion of FIG. 6.

FIG. 8 shows the insertion portion of the frame element on the right, inserted into a first connector housed in a frame element on the left.

FIG. 9 is an embodiment showing the insertion portion and the first and second connector members.

### DETAILED DESCRIPTION OF EMBODIMENTS OF THE INVENTION

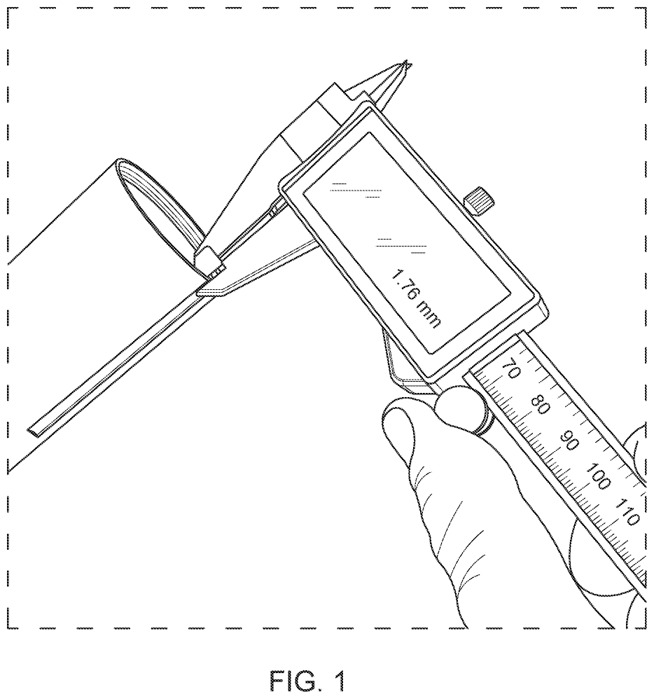

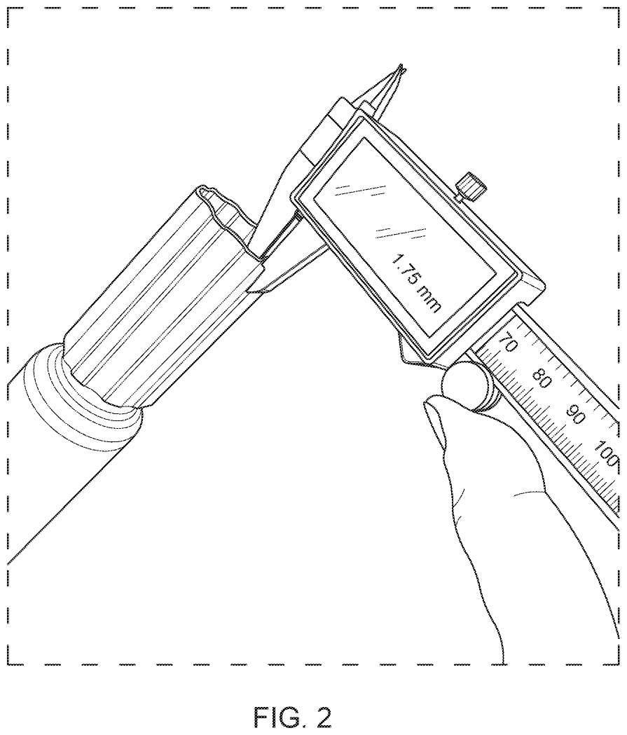

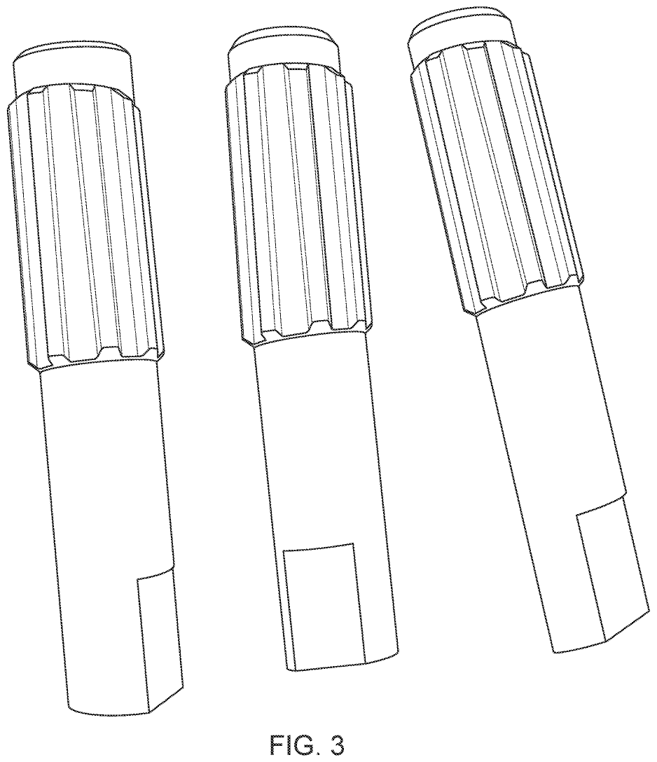

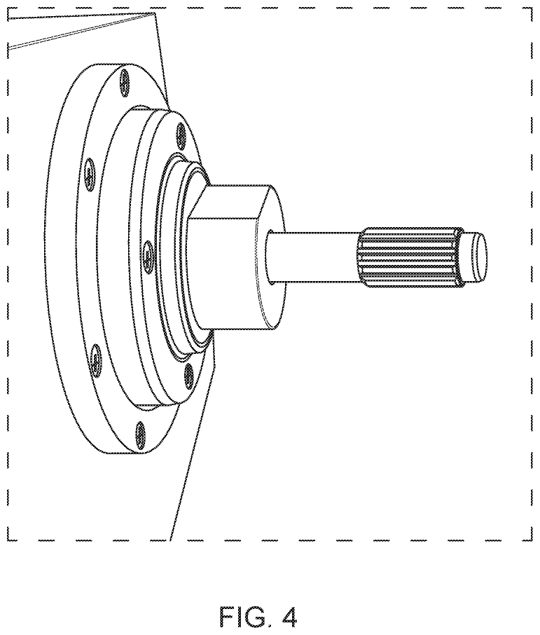

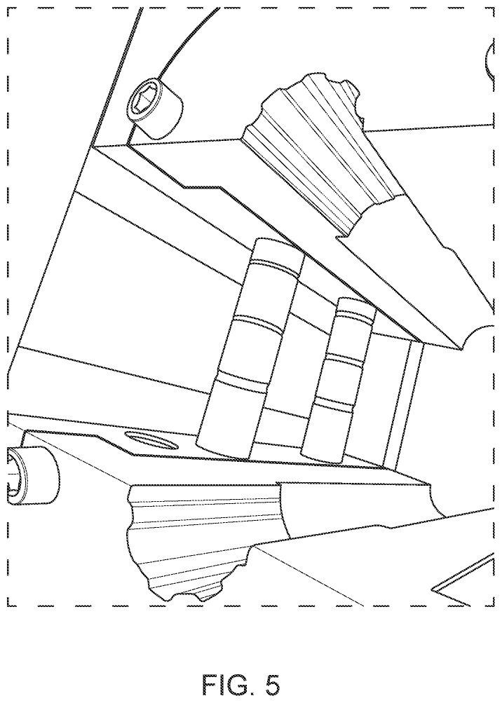

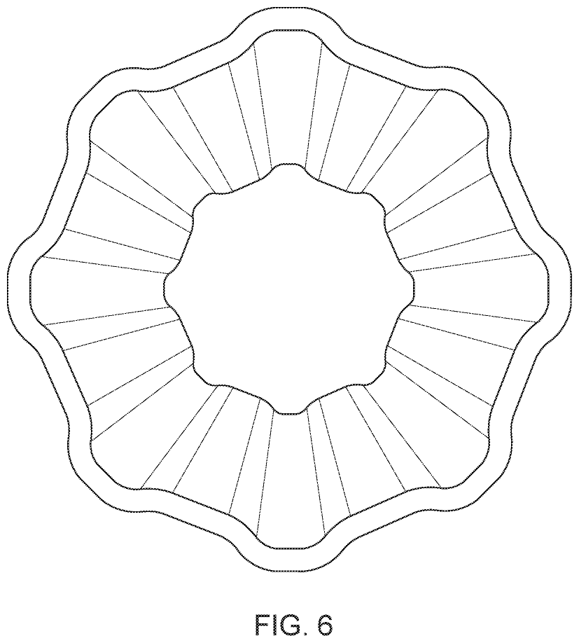

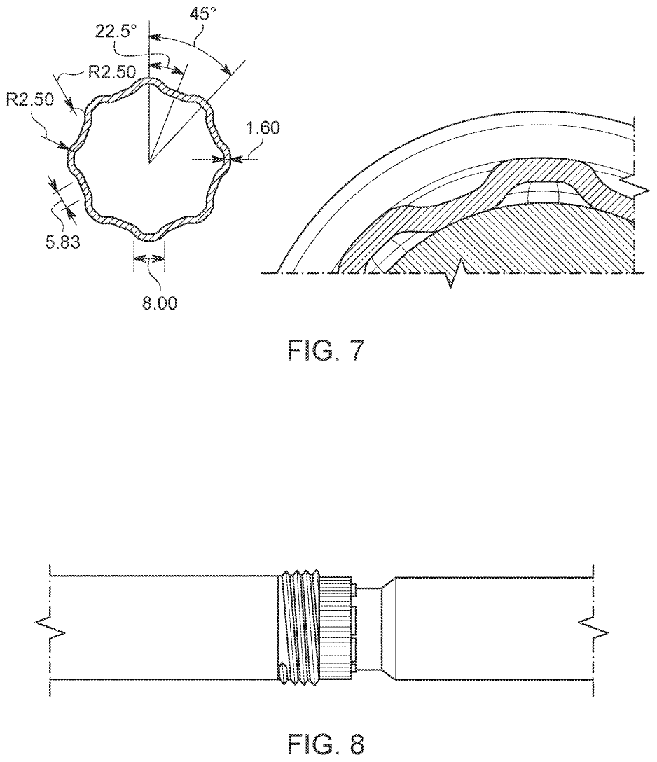

FIG. 1 shows the frame element prior to the method of forming the splines. The thickness of the tube wall is about 1.76 mm. It should be understood that this is exemplary and other tube thicknesses can be accommodated as described. Following swaging and then internal forming, the tube wall of the insertion portion is about 1.75 mm, which is about the same as the starting thickness (FIG. 2). The mandrels used to form the splines are shown in FIG. 3. These mandrels are each different in terms of the number of spline moulds around the outside periphery, and the thickness and height of the splines. FIG. 4 shows one of the mandrels ready to perform the internal forming process in the apparatus. The mandrel slides into a swaged tube and then the complementary forming tool shown in FIG. 5 is activated to press over the tube and onto the mandrel. When the tube is withdrawn the shape is now modified as seen in FIG. 6. A unique feature of this process is that the outside tube will is necessarily formed around the shape of the splines, so the inner wall and outer wall have complementary shapes. The technical drawing showing the dimensions required to form the shapes seen in the photo of FIG. 6, is provided in FIG. 7. FIG. 8 shows the insertion portion inserted into a first connector of a universal connector.

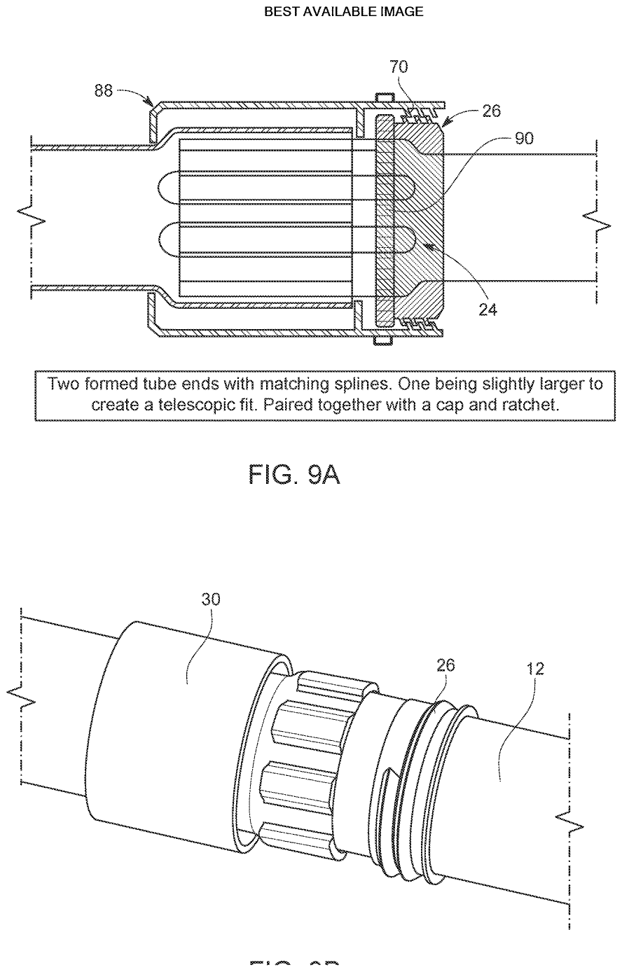

FIGS. 9A and 9B takes the numbering from the original PCT patent specification to show an embodiment in which the first connector member 24 forms protrusion 26. The protrusion 26 is threaded which allows for the connection assembly 70 form. Ratchet arm 90 is shown in schematic of FIG. 9A in the cross section but is not shown in the photo FIG. 9B for clarity. It should be understood that the protrusion 26 can comprise a ratchet part in FIG. 9B. The important features of the connector are shown being that there is a barrier at either end of the second connector member 30 with one end of the connection being an abutment and the other end of the connection being a threaded connection. In the present embodiment, the protrusion 26 provides the threaded connection.

### Experimental Testing

Existing tube to tube joins with push pin connectors and 2 mm shoulder wall thickness were tested for structural integrity. Pressure of about 375 kgs was applied in 20 kgs increments, to see the exact point the frame starts to deform and how much it would deform by each time weight is increase.

Tube diameter of 44.5 mm and wall thickness 1.6 mm did not catastrophically deform on a trampoline frame under applied pressure. This supports the argument of having a wall thickness of 1.6 mm in a shoulder of the proposed new frame element with insertion portion with splines.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

### APPENDIX

According to a first aspect there is provided a connector system for an apparatus intended to be walked on, swung on or jumped on in use, the connector system comprising
a plurality of frame elements, each frame element comprising an insertion portion comprising at least one protrusion; and frame element rotation reducing portions,
a plurality of first connector members, each first connector member configured to receive the insertion portion of at least one frame element into a channel therein;
   a plurality of second connector members, each second connector member configured to mate with one first connector member,
whereupon insertion of the insertion portion of at least one frame element into one first connector member, and mating of the one first connector member with one second connector member,
   the frame element cannot be removed from the first connector member due to the at least one protrusion of the frame element engaging with the second connector member; and
   the frame element is substantially unable to rotate in the first connector member due to the rotation reducing portions engaging with the channel of the first connector member.

The connector system can therefore provide a structurally stable frame assembly that is substantially more rigid that other frame assemblies that do not make use of the connector system. It is thought that by substantially preventing rotation of each frame element, and by substantially preventing removal of each frame element from the connector (comprising the first connector and the second connector), the rigidity of the frame is increased compared to the same frame without the connector assembly described.

In another aspect there is provided a connector system for frame elements, the connector system comprising
a frame element comprising an elongate body with a longitudinal axis, the elongate body having a first end and a second end, wherein at one or both of the first end and second end of the elongate body there is provided an insertion portion, the insertion portion comprising a protrusion or series of protrusions around the outside periphery of the frame element, the protrusion or series of protrusions around the outside periphery of the frame element having a first side and a second opposing side and providing a portion of increased diameter on the insertion portion;
a first connector member having an outside surface and an inside surface, the inside surface defining a channel therein, the channel having a rear wall and a front wall, the front wall defining an opening, wherein the insertion portion of the rod or tube can be inserted through the opening into the channel, wherein the frame element is insertable into the channel until either of the first end of the frame element contacts the rear wall which prevents further insertion movement of the frame element, or the first side of the protrusion or series of protrusions contacts the front wall of the first connector member and the frame element is thereby prevented from further insertion movement into the channel;
a second connector member that can be brought into contact with the first connector member inserted into the channel, the second connector member comprising a barrier wall that once in place can abut the second side of the protrusion or series of protrusions, the second connector member further comprising a connection assembly associated with the barrier wall and configured to engage the second connector member to the first connector member so that the protrusion or series of protrusions is/are sandwiched between the first connector member and the second connector member, wherein the frame element cannot be removed from the connection system until the second member is disengaged from the first connector member;
wherein the insertion portion of the frame element comprises a series of frame element rotation reducing portions which mate with an inside surface of the channel of the first connector to prevent or at least reduce rotation of the frame element once inserted into the first connector member.

In an embodiment, the frame element rotation reducing portions are longitudinal axially fixed indexed splines. There may also be first connector rotation reducing portions in the form of longitudinal ribs on the inside surface of the first connector, which provide grooves between them which mate with the axially fixed indexed longitudinal splines, to thereby substantially prevent rotation of the frame element.

The spline on the frame element is similar to that used in a drive shaft for example in a car or truck. Splines are essentially ridges or teeth on a drive shaft that match with grooves in a mating piece and transfer torque to it, maintaining the angular correspondence between them. In these well-known applications, the spline can resist or transmit rotational forces measured as torque. At the same time the spline in a drive shaft is designed to allow axial movement with little resistance. This is important so that as the shaft changes angular position through a coupling, the axial distance may change. The most common example of this is the drive shaft to the rear axle assembly of a car or truck. When moving up and down, there are changes in the angle of the drive shaft and it also moves the shaft forward and back a small amount axially. The sliding action removes conflict of the slightly changing length of the shaft. Also, a spline in a drive usually allows the same number of possible mating connections as the number of teeth used.

The present axially fixed indexed splines are a unique spline connection that while resisting rotational movement from the mating connections, also resist axial movement by using a barrier wall provided forward of the front wall of the longitudinal spline teeth. The barrier wall axially fixes the splines. This is a new and unique way of using a spline mating connection that makes the connection suitable for use in fixed joints. The connector is easy to assemble by being a close fit without resistance, yet the interlock feature prevents axial movement when locked in position.

Another unique feature of the present axially fixed indexed spline connection is indexing. Whereas splines have a number of teeth in the mating connections, these normally have no relevance with respect to which mating alignment is used. However, in the present connector, the mating is used for angular indexing. For example, in an eight-tooth spline there is provided for fixed connections to be connected at 45 degrees, 90 degrees, 135 degrees, 180 degrees, 225 degrees, 270 degrees and 315 degrees. This allows for frame structures to be created with instruction that are many and varied whilst remining indexed.

In yet another aspect there is provided a connector system for frame elements, the connector system comprising
a frame element comprising an elongate body with a longitudinal axis, the elongate body having a first end and a second end, wherein at one or both of the first end and second end of the elongate body there is provided an insertion portion, the insertion portion comprising a protrusion or series of protrusions around the outside periphery of the frame element, the protrusion or series of protrusions around the outside periphery of the frame element having a first side and a second opposing side and providing a portion of increased diameter on the insertion portion;
a first connector member having an outside surface and an inside surface, the inside surface defining a channel therein, the channel having a rear wall and a front wall, the front wall defining an opening, wherein the insertion portion of the rod or tube can be inserted through the opening into the channel, wherein the frame element is insertable into the channel until either of the first end of the frame element contacts the rear wall which prevents further insertion movement of the frame element, or the first side of the protrusion or series of protrusions contacts the front wall of the first connector member and the frame element is thereby prevented from further insertion movement into the channel;
a second connector member that can be brought into contact with the first connector member inserted into the channel, the second connector member comprising a barrier wall that once in place can abut the second side of the protrusion or series of protrusions, the second connector member further comprising a connection assembly associated with the barrier wall and configured to engage the second connector member to the first connector member so that the protrusion or series of protrusions is/are sandwiched between the first connector member and the second connector member, wherein the frame element cannot be removed from the connection system until the second member is disengaged from the first connector member;
wherein the first connector member comprises a series of teeth arranged around the periphery of the outside surface of the channel, and the second connector member comprises at least one ratchet arm, engageable with teeth during connection of the second connector member to the first connector member;
   wherein the connector system is thereby configured to generate an aural indicator as the second connector member is screwed onto the first connector member.

The connection system of the present invention can be used with any frame elements including rods, tube, pipes, poles and bars. The frame elements can be solid or hollow. Typically, the frame elements are hollow to minimise costs in manufacture and to provide a cost saving in weight. The frame elements to be connected can be those typically used in the scaffold or play equipment industry, and which are then modified by the connector system or connector assembly of the present invention. In an embodiment, the frame elements are themselves modified for use with the present connector system. The frame elements can be used to build any structure including but not limited to playground frames such as monkey bars, scaffolding, beds, tents, trampolines, swing sets, and so on.

Each frame element such as rod or tube, for exemplary purposes, can have an elongate body. The body can be straight or curved. The body of the frame element can have any cross-section. The most typical cross-section for frame elements is circular, although the invention is not limited to frame elements of this shape. In an embodiment, the cross section is at least about 40, 45, 48 mm in diameter. In an embodiment, the cross-sectional distance of the frame element is 44.5 mm. The wall thickness can be in the range of 1.5 to 3 mm. In an embodiment the wall thickness is at least about 1.5, 1.6, 2.0 or 2.5 mm in thickness. The frame elements can be made from any material. In an embodiment, the frame elements are made from metal. The elongate body can have a first end and a second end. The first end and the second end can be identical except in the case of frame elements where the thickness or shape of the frame element changes along its length. The first end of the frame element can be for joining with the second end of another, separate frame element. The second end of the frame element can be for joining with the first end of another, separate frame element. The first ends and the second ends can in principle be joined together in perpetuity. However, at some point, there may be a natural end of the structure, which will result in an end of a frame element that is not joined to another frame element. The ends of the frame elements which are not joined to other frame elements can be capped. There may be no free ends if the structure is such that all ends of the frame elements are connected, such as in a cuboidal shape.

The end of the frame element that will join with the connector can have an insertion portion. The insertion portion is intended for insertion into the body of the first connector. The insertion portion can be of any length. If the insertion portion is too short, there is a risk that the point of connection is not strong enough and the frame element may move too much in the first connector. It is preferred that the insertion portion is at least equal in distance along the frame element to the diameter of the frame element. For example, if the diameter of the frame element is N cm, then the insertion portion is at least equal to N cm. In some embodiments, the insertion portion is at least about twice, 5, 10 or 15% greater in length than the diameter of the frame element. If the frame element is not round (and therefore has no diameter) then instead of the diameter, the distance can be measure as the longest length from one side of the cross section to the other e.g. in a square, the diagonal distance from opposing corners.

In an embodiment, the insertion point can comprise one or more protrusions around the frame element body. The function of the protrusion(s) is to provide a part of the frame element that can be gripped between the first connector and second connector members in use. In an embodiment, the protrusion(s) on the frame element can be identified as the part which stops the insertion portion from being further inserted into the channel. Alternatively (or in addition), the protrusion(s) can be identified as the part that abuts the barrier wall of the second connector member and substantially prevents or at least reduces removal of the frame element from the first connector member.

In an embodiment, the insertion portion is different in diameter to the remainder of the elongate body of the frame element. This can be useful where the insertion portion slides into the first connector member and is secured into position by a second connector member where the outside surfaces of the elongate body of the frame element and second connector member can be substantially flush with one another. There can be some step in the change between surfaces. However, being as flush as possible can provide a more aesthetically pleasing join that is also functionally useful if, e.g. something needs to slide along connected frame elements.

In a frame element with a substantially circular or ovaloid cross section, where there is a single peripheral protrusion, the protrusion can be referred to as a circumferential protrusion. In frame elements with other shapes, such as triangular, the formation of a protrusion around the outside surface can be referred to as circumferential, even though it will be appreciated that it is not circular in shape. Nevertheless, the protrusions can trace around the outside of the frame element body and provide an area of increased diameter or increased cross sectional width for the frame element. The increase in cross sectional area can be relative to the remainder of the body of the frame element that does not comprise the protrusion(s).

There can be one circumferential protrusion. In the case of a frame element with a circular cross-section, the protrusion can be an annular ring. The ring can be a solid shape with squared edges. The ring can have rounded edges. There can be a preference for solid edges as will become apparent from the description herein, since the protrusions will thus be sandwiched without air spaces between the first and second connector members if they have squared edges. Since the function of the protrusion is to provide an area of increased diameter on the frame element, the protrusion does not have to be a solid ring around the element body and instead it can be provided in parts. Where the protrusion is provided in parts it can be referred to as a series of protrusions around the outside periphery of the frame element. The series of protrusions can be of any shape such as knobs, squared, rectangular columns, other. Each protrusion can be formed into the material of the frame element e.g. by moulding, pressing or crimping. Each protrusion can be material added to the frame element e.g. by adhering a solid piece or adding a rivet. The protrusion(s) can be hollow. The protrusion(s) can be solid. There can be any number of protrusions around the outside periphery in a series including 2, 3, 4, 5, 6, 7, 8, 9 or 10. If there are too many protrusions, the risk is that they become a point of weakness since the surface area joining them to the underlying structure gets less and they could break off more easily. The protrusion(s) whether in single form or parts can be formed by or accompanied by longitudinal splines can be axially fixed and which allow for indexing of the frame element with the first connector. The axially fixed indexed splines extend along at least a part of the longitudinal length of the insertion portion. The protrusions can be the leading edges of the axially fixed indexed longitudinal splines. These splines can assist with decreasing rotation of the frame element once inserted into the first connector member if there are corresponding grooves between complementary ribs inside the channel of the first connector to reduce rotation.

In an embodiment there are a plurality of axially fixed longitudinal splines around the outside periphery of the insertion portion. Each spline can be in one single piece. Each spline can be formed in multiple pieces with lands between elongate spline parts. Each spline can be at least or at most 2, 3, 4, 5, 6, 7 or 8 mm (or larger) in thickness from one side of the spline to the other. The spline can be formed in two or more longitudinal spline parts to reduce the amount of material used to form it. The spline can be across 75, 80, 85, 90, 95 or 100% the distance of the insertion portion. Although there should be at least some part of the insertion portion free from the location of the barrier wall of the second connector member. Each spline can have an elongate axis substantially aligned with the longitudinal axis of the frame element; this is the most straightforward arrangement since the frame element is most easy to insert into the first connector member. In an alternative embodiment, each spline is offset with respect to the longitudinal axis of the frame element. In this embodiment, the arrangement is slightly more complicated because the receiving channels for the offset splines still need to be able to receive and mate with them to prevent or reduce rotation. In an embodiment with angled offset splines, the channels for receiving them will need to be wider, which results in less overall contact between frame element and first connector. There is still likely to be an overall reduction in rotation, but the optimum reduction is where straight splines contact with straight ribs in the channel of the first connector. In an embodiment, the splines could be curved so that they mate with the corresponding parts of the first connector member upon rotational insertion into the first connector member.

In order that the splines are repeatedly matingly received into a first connector member it is preferably that each spline is the same. The splines can be the same across multiple frame elements, so any frame element can be mated into any first connector. In an embodiment, the splines can be different around a single frame element so that there is only one way in which they can possibly be inserted into a correspondingly shaped first connector member. This would increase complexity during construction but may provide some advantages such as forcing a particular orientation of respective frame elements relative to one another.

There can be any number of splines around the outside periphery of the insertion portion. There could in principle be a single spline with a corresponding channel on the inside surface of the first connector member; however, to optimise a reduction in rotation of the frame element in the first connector member, preferably there are splines all the way around the outside of the insertion portion. The splines can be equidistant from one another. There can be at least or at most 3, 4, 5, 6, 7, 8, 9, 10 or more splines. It is noted that with frame elements in which there is a bend or an elbow, the insertion of the insertion portion of the frame element into the first connector member needs to be in a particular way in order that the frame element lines up with other connectors. This indexing of the splines as they are mated into the first connector means that sometimes the frame element has to be inserted in a particular way for a frame to be formed. If there are too many splines, a chance that the frame element with an elbow is not oriented in the correct way are increased and the user has to keep removing the insertion portion and trying again to achieve the correct assembly. With this in mind, it is considered that about eight splines is optimal for reducing rotational movement between the frame element and the first connector member and for ease of construction.

Each spline has a first longitudinal side and a second longitudinal side. When the insertion member of the frame element is inserted into the first connector member the spline can slide into a channel or groove formed in the inside wall surface of the first connector member. Each elongate spline receiving groove in the channel in the first connector member can be formed between longitudinal ribs. Each rib of the first connector member can have a first side and a second side. The first side of the rib can abut with the first longitudinal side of a spline once the spline has slid into the groove and the two are unable to pass over one another. This means that rotational forces applied to the frame element are absorbed by the splines and ribs and the frame element is prevented or substantially reduced from rotating inside the first connector member.

In an embodiment there can be a single protrusion that does not cover the entire circumference (or periphery) of the frame element. Nevertheless, the protrusion can act to provide a part of the frame element that can be gripped by the first connector and second connector members in use. It should be understood that such a single protrusion is in scope but may not be preferred due to the decreased amount of surface area for gripping for the first and second connector members.

The amount that the protrusions extend from the frame element surface can vary. However, the protrusion or protrusions should not be so short that they are unable to provide a good functional surface for gripping by the connector members; or so that there is a risk that the insertion portion could be pushed too far into the first connector and get stuck. On the other hand, the protrusion or protrusions should not extend out so far that they are unsightly, difficult to manufacture, hamper handling and generally cause a nuisance. In a preferred embodiment, the protrusion(s) increase the diameter of the frame element by about 10 to about 20%, more preferably about 15 to about 18% from the original diameter of the frame element. For example, if the diameter of the frame element is 5 cm, the protrusion(s) can extend about 0.5 cm to thereby increase the overall diameter by 1 cm (about 20%). If the diameter of the frame element is 3.5 cm (measured from outside wall) then the diameter of the frame element can be increased to about 3.9 cm by the protrusions (about 10%).

While there may be multiple protrusions referred to, it should be understood that one protrusion is in scope so that section can be read as a singular protrusion unless the context makes clear otherwise.

The protrusions can be provided on the frame element. In this embodiment, the frame element is manufactured with the protrusion(s). Thus, the protrusions are integral with the frame element and cannot be removed from the frame element. Alternatively, the protrusions are provided on an element that is attachable to the frame element. For example, the end of the frame element could be capped with a sleeve that has a part of it comprising one or more protrusions around its outside periphery. Where the insertion portion is a cap, it can be made from a different material to the rest of the frame element. The cap can slide over the end of the frame portion and be secured around the outside wall. The cap can slide into the frame portion and be secured to the inside wall. The cap can be secured to the frame element by any means. The cap could be secured to the frame element by tight interference fit. To increase structural integrity, the cap could be secured to the frame element by crimping and or by fasteners. In a preferred embodiment, however, the insertion portion is moulded on the end of the frame element during manufacture, since this increases structural integrity by providing a single unitary piece and reduces overall unit cost.

The end of the insertion portion can be open. The end of the insertion portion can be closed If the insertion portion is formed from a cap, the end can be closed during manufacture. Where the end of the insertion portion is a moulded tube, the end will necessarily be open. To close the open end for aesthetic purposes, or for safety to ensure that rough edges are protected, there can be provided a capping button. The capping button can be secured by any means including a tight interference fit. The capping button could be marked with words, logo, or other information as desired.

Whether there is one or more protrusions, whether they are integral with the frame element or provided in a separate piece, the protrusions comprise a first side and a second opposing side. Upon insertion of the insertion portion of the frame element into the connector, the first side of the protrusions is facing forward towards the first connector. The second side of the protrusions is thus facing outwardly once the frame element is engaged with the first connector.

In a second aspect of the invention there is provided a connection system for rod and or tube-like frame elements, the connection system comprising a frame element such as a rod or tube comprising an elongate body having a first end and a second end, wherein at one or both of the first end and second end of the elongate body there is provided an insertion portion comprising an indentation or series of indentations located around the outside periphery of the rod or tube, the indentation or series of indentations around the outside periphery of the rod or tube providing a portion of decreased diameter when compared to the insertion portion and the remainder of the elongate body of the rod or tube, a first connector member having an outside surface and an inside surface, the inside surface defining a channel therein, the channel having a rear wall and a front wall, the front wall defining an opening, wherein the insertion portion of the rod or tube can be inserted through the opening into the channel, wherein the channel further comprises a protrusion or series of movable protrusions, the movable protrusion or series of movable protrusions being movable between a retracted position in which the rod or tube can be inserted into the channel, and an engaged position in which the protrusion or series of protrusion are located in the indentation or series of indentations provided in the rod or tube, the protrusion or series of protrusions thereby preventing removal of the rod or tube from the channel. Optionally, a second connector member is provided that can be brought into contact with the first connector member once the rod or tube has been inserted and engaged with the channel, the second connector member may comprise a connection assembly configured to engage the second connector member to the first connector member.

Description relating to the first aspect of the present invention also applies to the second aspect of the invention unless the context makes clear otherwise. For example, the connection system of both the first and second aspects of the present invention can be used with any frame elements including rods, tube, pipes, poles and bars. The frame elements of both the first and second aspects can be used to build any structure including but not limited to playground frames such as monkey bars, scaffolding, beds, tents, trampolines, swing sets, and so on.

In this embodiment, the insertion portion comprises one or more indentations around the frame element body. The function of the indentation(s) is to provide a part of the frame element that can be gripped by the first connector in use. In a frame element with a substantially circular or ovaloid cross section, where there can be a single peripheral indentation, the indentation can be referred to as circumferential indentation. In frame elements with other shapes, such as triangular, the formation of an indentation around the outside surface can be referred to as circumferential, even though it will be appreciated that it is not circular in shape. Nevertheless, the indentation can trace like a channel around the outside of the frame element body and provide an area of decreased diameter or decreased cross sectional width for the frame element. There can also be indentations arranged longitudinally along the insertion portion of the frame elements body.

There can be one circumferential indentation. In the case of a frame element with a circular cross-section, the indentation can be an annular ring. The ring can be a solid channel with squared edges. Since the function of the indentation is to provide an area of decreased diameter on the frame element, the indentation does not have to be a solid ring around the element body and instead it can be provided in parts. Where the indentation is provided in parts it can be referred to as a series of indentations around the outside periphery of the frame element. The series of indentations can be of any shape such as inverted knobs, squared, rectangular column channels, other. There can be any number of indentations in a series including 2, 3, 4, 5, 6, 7, 8, 9 or 10.

In an embodiment there can be a single indentation that does not cover the entire circumference (or periphery) of the frame element. Nevertheless, the indentation can act to provide a part of the frame element that can be gripped by the first connector in use.

The amount that the indentation(s) extend into the body of the frame element surface can vary. However, the indentation(s) should not be so short that they are unable to provide a good functional surface for gripping by the protrusion provided on the first connector member. In a preferred embodiment, the indentation(s) decrease the diameter of the frame element by about 10-20% from the original diameter of the frame element. For example, if the diameter of the frame element is 5 cm, the protrusion(s) can extend about 0.5 cm into the frame element thereby decreasing the overall diameter by 1 cm (about 20%). In the alternative, the indentations are provided as openings in the frame element wall with no closed bottom wall.

While there may be multiple indentations referred to, it should be understood that one indentation is in scope so that section can be read as a singular indentation unless the context makes clear otherwise.

The indentations can be provided on the frame element. In this embodiment, the frame element is manufactured with the indentation(s). Thus, the indentations are integral with the frame element and cannot be removed from the frame element. Alternatively, the indentations are provided on an element that is attachable to the frame element. For example, the end of the frame element could be capped with a sleeve that has a part of it comprising one or more indentations around its outside periphery.

Whether there is one or more indentation, whether they are integral with the frame element or provided in a separate piece, the indentations are configured to receive protrusions from the inside of the first connector member. Advantageously, the protrusions from the inside of the first connector member have a complementary shape, to provide a tight fit once engaged. However, provided there is some protrusion located into the indention, the unwanted removal of the frame element can be avoided. In an embodiment, there is a single indentation on the frame element, and the first connector member comprises a single protrusion that is movable into and out of the indentation. In an embodiment, there is an annular indentation on the frame element, and an annular protrusion located in the first connector element that is movable into and out of the annular indentation. The or each protrusion can be manually moved from the unlocked (retracted) to the locked (engaged) position with respect to the respective indentation. In an embodiment, the protrusion is spring biased into the channel and must be manually removed from the channel of the first connector member using a protrusion mover in order to locate the frame element. In an embodiment, the protrusion is spring biased out of the channel of the first connector member and must be manually forced into the channel using a protrusion mover in order to locate the frame element. The insertion portion so described in this embodiment can be equipped with the splines described above.

The connector of the present invention comprises a first connector member (sometimes referred to as a first connector) operable with a second connector member (sometimes referred to as a second connector). The first connector member comprises an outside surface which is accessible and manipulatable. The first connector member has an inside surface which is the wall defining the interior of a channel. The inside surface wall can be smooth. The channel inside the first connector can be integrally formed with the wall of the first connector. The first connector member can be provided by an insert that slides into a tube to form the first connector. To join the insert with the tube and prevent unwanted movement of it out of the tube during use, the tube and connector can be crimped together or otherwise fastened

In an embodiment, the first connector member is a separate handleable piece into which a frame element can be inserted. Where a connector has two (or three) first connector members the piece can be made and stored separately to the frame element. The frame elements for use with such connectors can have an insertion portion at each end of the frame element. In other embodiments, where a frame element to frame element join is required, the frame element can have an insertion portion at one end, and a first connector member at the other end. The first connector member can be held into the end of the frame element by tight interference fit. However, to further ensure absolutely no removal of it in use, there can be other securing means of the first connector into the end of the frame element such as by using glue and or taper. Furthermore, the first connector member can comprise a sleeve which slides into the frame element. The sleeve can comprise an indentation. A complementary protrusion can be formed into the frame element to conform to the indentation in the frame element. The protrusion/indentation can be circumferential. The pieces can be crimped together to ensure that one is not readily removable from the other in use.

The channel in the first connector is configured to allow insertion of the insertion portion of the frame element. The channel can be slightly wider than the insertion portion of the frame element to ensure that it can fit therein. In a preferred embodiment, the channel is about the same diameter as the frame element so as to allow a tight interference fit. Once inserted into the channel, the frame element, subject to what shape it is, may be able to rotate in the channel unless there are means which prevent that rotation. As noted above, in order to prevent or at least reduce any unwanted rotation, the inside surface of the channel can be modified with rotation reducing portions to engage the frame element. The first member rotation reducing portions can be ribs forming channels in the channel wall. The ribs can be received into complementary recesses between splines, as described, provided on the frame element. The frame element would thus be substantially prevented from rotating in the channel since the ribs and splines would not allow for rotational movement. The frame element itself is thus also modified with frame element rotation reducing portions. In an embodiment the frame element rotation reducing portions are provided on a frame element that is modified with a cap that provides the protrusion or series of protrusions. In an alternative embodiment, the frame element rotation reducing portions are formed into the frame element during manufacture.

The first member rotation reducing portions on the inside wall of the channel of the first connector can extend along a part of the inside surface of the channel of the first connector. The first member rotation reducing portions can each have a top surface, a rear end wall near the back of the channel, and a forward end wall near the opening of the channel. The top surface of the first member rotation reducing portion can be wide. The top surface of the first member rotation reducing portion can be narrow. There can be as few as 6 first member rotation reducing portions, there can be up to 20 first member rotation reducing portions, depending on the width of the top surface of each portion and the number of splines provided on the frame element. Once mated the frame element rotation reducing portions and the first member rotation reducing portions abut one another and substantially prevent rotational movement. There can be one or two (or more) first member rotation reducing portions between each pair of frame element rotation reducing portions.

The channel has an opening through which the insertion portion of the frame element is received. The opening can be defined by a front wall of the channel which can be a rim around the front of the first connector member. The front wall at the forward part of the first connector can have a smooth flat surface which in some embodiments can be for engagement with the first surface of the protrusion or series of protrusions. In some embodiments, the front wall of the first connector comprises the forward end walls of any rotation reducing portions provided in the channel. Therefore, the front wall can be the rim around the front of the first connector; the forward end walls of any rotation reducing portions provided in the channel; or both provided together. Upon insertion of the frame element into the opening, the protrusion or series of protrusions can abut against the front wall and or the forward wall of the rotation reducing portions which thereby provide a natural stop for further insertion movement of the frame element into the channel. In embodiments, the front wall and or the forward walls of the rotation reducing portions can be modified so as to dovetail with the protrusion(s), so as to further prevent any rotational movement of the frame element once inserted. The front wall of first connector can also dovetail with the second connector in some embodiments.

In some embodiments, the front wall can be modified with at least one gripper. Each of the grippers can be configured to engage with the protrusion(s). When sliding into the channel, the protrusion(s) can slide under finger like grippers extending from the front wall which engage over the protrusion(s) and grip by them. The grippers prevent the frame element from being unwantedly withdrawn from the first connector in use. In embodiments in which there is a gripper, the first side of the protrusion or series of protrusions contacts the front wall of the first connector member by engagement of the grippers with the protrusion(s). The rod or tube is thereby prevented from further insertion movement into the channel.

The channel also has a rear wall, and in this embodiment, the first end of the frame element may or may not abut the rear wall prior to the direct contact between the first surface of the protrusion or series of protrusions, and the front wall of the first connector member. The rear wall can be a solid wall at the rear of the channel. The rear wall can be a partial wall or barrier at the rear of the channel. In some embodiments, upon insertion of the insertion portion of the frame element into the channel, the first end of the frame element abuts the rear wall of the channel before the protrusion or series of protrusions contact with the front wall. In some embodiments, the protrusion or protrusions will never contact the front wall and the only stop is the barrier at the rear wall. In embodiments, therefore, the rear wall provides a natural stop for further insertion movement of the frame element. In this embodiment, if there are protrusions, there may be a gap between the front wall and the protrusion or series of protrusions. In embodiments, the rear wall can be modified so as to interlock with the first end of the insertion portion of the frame element, so as to further prevent any rotational movement of the frame element once inserted. The interlocking can be by a lock and key type of complementary shaping applied to the respective contacting surfaces.

In order to complete the connector, the second connector member is brought into contact with the first connector member. The act of bringing the two members (first connector member and second connector member) into contact can comprise bringing either one of them towards the other. However, in practice, since the frame element is typically already inserted into the first connector member, the act of bringing the second connector member into contact with the first connector member comprises brining the second connector member to the first connector member.

In an embodiment, the second connector member is in two or more parts and it is assembled around the first connector member. The second connector member can be in parts that are hingedly (or otherwise) connected to one another and which can be clamped around the first connector member and then locked into position. The second connector member can have an open position which can receive the first connector member and a closed, locked position in which the second connector member is locked around the first connector member. To lock the second connector member that comes in a plurality of parts into place around the first connector member, there can be a locking mechanism that comprises screws, hook and tab or other.

In an embodiment, the second connector comprises two half-parts a first half-part and a second half-part which can be different from one another or identical to one another. If the two half-parts are identical, once the second half-part is inverted with respect to the first half part, the two half-parts together provide a collar. Each half part can have first joining side and a second joining side. A catch can be provided at the first joining side, the catch can provide a recess. A boss can be provided at the second joining side, the boss can be locatable into the recess of the catch. When the two half-parts are brought together, the respective catches can locate the respective bosses and the two half parts are held securely together around the first connector member. A tool may be required to separate the parts once connected. In an alternative embodiment, the two half parts are not identical. This can be advantageous for making sure that the two half parts are connected in the correct way. Where the two half-parts are identical, there is a chance that one is connected to the other upside down. With two different parts, manufacturing costs might increase but ease of assembly is decreased.

Once in place, in an embodiment, the second connector member can provide a barrier wall that abuts the second side of the protrusion or series of protrusions. The barrier wall thereby prevents any removing movement of the frame element from the channel of the first connector member. The barrier wall can be provided as one continuous wall covering the second side of the protrusion or series of protrusions. The barrier wall could also be provided in separate wall parts provided that the protrusion or series of protrusions abut against it and their movement is barred. In another embodiment, protrusion(s) inside the channel locate into indentation(s) on the frame element and prevent the removal of the frame element from the first connector. In this embodiment, the second connector member provides additional structural integrity to the connector member, reducing any tendency for the frame element to move when pressure it applied in use.

In an embodiment, the second connector member is in one part. When the second connector member is in one part, it is necessary that it has a passageway therethrough to receive the frame element. The second connector member can be passed over the frame element and brought towards the insertion portion inside the channel of the first connector member. Once in place around the first connector member, the second connector member may provide a barrier wall that abuts the second side of the protrusion or series of protrusions. The protrusion(s) may be as described herein integral with the insertion portion. Alternatively, the protrusion(s) may be provided by a washer that slides over the insertion portion. The barrier wall thereby prevents any removing movement of the frame element from the channel of the first connector member.

In an embodiment, the second connector member is in two parts. A barrier wall can be provided on each of the second connector member parts e.g. first and second half-parts. An advantage of the second connector member being in parts which are assembled around the first connector member is that the second connector member can be narrower in diameter. Without the need to slide over the frame element, the second connector member can be made thinner and more streamlined with the first connector member. This can be more aesthetically pleasing and improves functionality under circumstances where the bulkiness of the connector would be disadvantageous. In some embodiments, in which the frame elements are for playground equipment, having a narrow connection point with flush connectors can be useful where there are parts of the equipment that slide over each other (e.g. in a flying fox). Furthermore, any locking latches and bosses as described are preferably as streamlined as possible for aesthetics and safety in use.

The second connector member comprises a connection assembly. The connection assembly can be associated with the barrier wall. The connection assembly is configured to engage the second connector member to the first connector member. The function of the connection assembly is to prevent unintentional disengagement of the second connection member from the first connection member. This can prevent unintentional disengagement of the barrier wall from the second side of the protrusion or series of protrusions, which would be disadvantageous in embodiments in which the barrier wall is holding the whole system together. The connection assembly can be any means that reversibly connects the second connection member to the first connection member.

In an embodiment, the connection assembly is a series of complementary ribs and recess (or protrusions and apertures; or like) on the outside wall of the first connector member and the inside wall of the second connector member that are complementary shapes and which upon engagement cause the first connector member and the second connector member to be interlocked together to prevent disengagement of the second connector member. The connection assembly can also prevent any rotational movement of the second connector member relative to the first connection member when locked into position. The connection assembly can operate together with the locking mechanism on the second connector member to reversibly engage the two members (first connector member and second connector member) to one another.

In an embodiment of the connection assembly, the complementary ribs and recesses on the outside wall of the first connector member and the inside wall of the second connector member come in the form of screw threads. In this embodiment, the second connector member can be screwed onto the first connector member to be interlocked. In an embodiment in which the second connector member is forms in parts, the parts can be assembled and then the assembled second connector member can be screwed onto the first connector member.

As the second connector member is screwed onto the first connector member in a first direction, the barrier wall moves closer to the protrusion or series of protrusions. When the barrier wall abuts the second side of the protrusion or series of protrusions, the second connector member can be given one last tightening turn and then it substantially remains in position. The second connector member can be turned in a second direction that is opposite to the first direction to remove or disengage it from the first connector member. When the second connector member is required to be removed from the first connector member, it can be turned in the second direction until the barrier wall is moved away from the protrusion or series of protrusions and the threads disengage.

In an embodiment, the second connector member is a collar that passes over one or more grippers that have engaged with the protrusion(s). Where each gripper is required to be pulled away from the protrusion(s) to remove the connection, the second connector member can hold them into position and ensure that they are unable to release their gripping forces. In this embodiment, the second connector member comprises a barrier wall itself that once in place causes engagement of the protrusion or series of protrusions by the grippers of the first connector member to remain engaged. In this embodiment, the second connector member can further comprise a connection assembly associated with the barrier wall, i.e. a screw thread or interference fit, that is configured to engage the second connector member to the first connector member. When viewed in cross section, it would be seen that the first connector member (i.e. the grippers thereof) is sandwiched between the protrusion or series of protrusions and the second connector member. The rod or tube thereby cannot be removed from the connection system until the second member is disengaged from the first connector member.

To assist in applying the second connector member to the first connector member in embodiments, the outside wall of the second connector member can be modified with a gripping surface. The gripping surface can include one or more gripping ridges that allow for purchase to be applied to the second connector member to force it into position.

To indicate to the user when the second connector member is in location such that the protrusion or series of protrusions is/are located or sandwiched between the first connector member and the second connector member there can be provided an indicator. The indicator can be a visual indicator. The indicator can be an aural indicator. In an embodiment, the indicator is a click sound that is made when the barrier wall of the second connector member engages with the front wall of the first connector member.

In an embodiment, as the connection assembly is formed by screwing the complementary screw threads to one another, there is an aural indicator of the joining process. This can be provided by at least one ratchet arm provided in the second connector body. The flexible ratchet arm can be biased to a position flush with the second connector body wall, but the ratchet arm can be lifted if a head part of the ratchet arm is forced outwardly from the wall of the second connector. The ratchet arm engages with teeth arranged in formation around the forward peripheral edge of the outside wall of the first connector member. The ratchet arm can be located on the second connector body such that it engages with a tooth of the first connector just prior to the threading process. As the second connector is screwed onto the first connector, the ratchet arm rises over the tooth body and then falls onto the next tooth in series. Advantageously, in embodiments in which there is one row of teeth, the ratchet arm is sized relative to the teeth so that it engages with them over more than one turn. Alternatively, there can be more than one row of teeth in a spiral formation that complements the turning circle of the ratchet arm.

Nevertheless, the sequential connection of the ratchet arm with the teeth in the series makes a sound each time the head part of the ratchet arm falls to another tooth. Over a few turns of the second connector relative to the first connector there can be a loud and pleasing mechanical sound that allows the user to at once know that the first and second connectors are bring securely joined, and that the join is as tight as possible since the noise stops. An additional advantage of the ratchet arm, in embodiments, is that once the first connector and the second connector are joined, they are unable to come loose relative to one another because the head part of the ratchet arm may prevent an unscrewing motion. The head part of the ratchet arm can abut the preceding tooth and the bias in the material will not allow rotational movement in the opposite direction. There can be one ratchet arm per half part of the second connector.

In alternative embodiments, the ratchet arm comprises only the head part in the form of a thin fin which depends inwardly from the wall of the first half part or second half part. The thin fin flicks over each of the teeth in the series as the second connector is turned. This sort of ratchet arm will not prevent an undoing movement, but will still provide the aural indicator during tightening.

The number of the teeth and the size of the head part of the ratchet arm will contribute to the loudness and frequency of the aural indicator. In an embodiment in which the diameter of the first connector is about 3.5 cm there are about 32 teeth around the outside periphery of the opening. However, there can be at least about or at most about 10, 20, 30, 40 or 50 or more teeth depending on the size of the first connector. Each tooth can have a slope portion over which the ratchet arm moves in a forward screwing direction and a stop portion. As the head of the ratchet arm falls off the end of the slope portion of a first tooth, the head part of the ratchet arm can fit into the gap defined by the slope portion of a second tooth and the stop portion of the adjacent first tooth. The stop portion of any one tooth prevents rotational movement in the unscrewing direction, since the head of the ratchet arm cannot move past the stop portion in the unscrewing direction. In an embodiment, the slope portion of each tooth and the stop portion of each tooth is the same dimension. This means that each tooth provides for the same tone or pitch of sound as an aural indicator. In an alternative embodiment, the slope portion and the stop portions of each tooth are different angles, lengths and or heights, which makes a different sound (pitch or tone) for each tooth as the ratchet head moves over each different tooth. By varying the teeth and therefore by changing the corresponding sound emitted a tune could be created. The tune could have a simple melody such as Twinkle Twinkle Little Star. This could be extremely pleasing to children helping their parents to assemble play equipment. It is also fun for parents to guess what tune will come next. The sounds could act as a motivator to keep assembling.

1-15. (canceled)

16. A playground apparatus comprising the following play features:
(i) a frame structure formed from a plurality of upright support poles, and a plurality of horizontal bars configured for a user to climb or swing,
the upright support poles and horizontal bars forming at least one quadrilateral in the frame, the quadrilateral having four corners;
wherein tightenable cross bracing is provided in the quadrilateral to reduce or prevent unwanted movement of the quadrilateral during use wherein the cross bracing extends as a diagonal support from each of the four corners of the frame structure
(ii) at least one play feature associated with the cross-bracing that can be climbed on and or through in use.

17. The playground apparatus of claim 16, wherein horizontal bars of the quadrilateral comprise an upper horizontal bar towards the top of the frame and a lower horizontal bar, and the lower horizontal bar is close to the ground.

18. The playground apparatus of claim 16, wherein the cross bracing comprises cables tightenable by turnbuckles.

19. The playground apparatus of claim 16 wherein the cross bracing is provided by brace members, such as cables, which are tightenable towards one another from the centre of the quadrilateral.

20. The playground apparatus of claim 16, wherein with the cross bracing installed, the upright support poles of the frame move about 2, 5 or 8 mm from its vertical resting position under applied forces.

21. The playground apparatus according to claim 16, wherein the at least one feature comprises one or more of: cables configured for climbing, cargo net and netting with openings configured for climbing through.

22. A kit comprising the components used to form the playground apparatus of claim 16 along with associated instructions on how to assemble the components to form the playground apparatus.
